(19) United States
(12) Patent Application Publication
(10) Pub. No.: US 2019/0037934 A1
(43) Pub. Date: Feb. 7, 2019

(54) SAFETY VEST

(71) Applicants: Allison S. Swank, Gibsonia, PA (US); Andrew R. Swank, Gibsonia, PA (US)

(72) Inventors: Allison S. Swank, Gibsonia, PA (US); Andrew R. Swank, Gibsonia, PA (US)

(73) Assignee: VisionVest, LLC, New Kensington, PA (US)

(21) Appl. No.: 16/052,972

(22) Filed: Aug. 2, 2018

Related U.S. Application Data
(60) Provisional application No. 62/670,262, filed on May 11, 2018.
(60) Provisional application No. 62/540,216, filed on Aug. 2, 2017.

(51) Int. Cl. A41D 13/01; A41D 1/04; A41D 1/00; A41D 27/20; G01S 19/13; H02S 99/00; G08B 21/02; H04W 4/021; H04W 4/029; H04W 4/02

(52) U.S. Cl. CPC A41D 13/01; A41D 1/04; A41D 1/005; A41D 27/205; G01S 19/13; A41D 2400/48; G08B 21/02; H04W 4/021; H04W 4/029; H04W 4/027; H02S 99/00

(57) ABSTRACT

A safety vest assembly with enhanced visibility in a range of limited visibility conditions, integrated hydration pockets, and optional integrated technology is provided. The vest generally includes front and back panels with at least one band of reflective material and at least one band of lights on outward facing surfaces. Also included are pockets configured for storage of refreshments and optionally at least one electronic device. Power for the lights and additional technologies is provided by an integrated power supply, and controlled by one or more switches configured to modulate a function of the lights. The integrated technologies include a power port configured for attachment of an electronic device, a vest location device (GPS, cellular), an accelerometer, and an alert system. The safety vest assembly may be included as part of a worker safety system that includes a control system configured to communicate with a wearer of the safety vest.

### CROSS-REFERENCE TO RELATED APPLICATIONS

The present application claims the benefit under 35 U.S.C. § 119(e) of prior U.S. Provisional Application Ser. Nos. 62/540,216, filed Aug. 2, 2017, and 62/670,262, filed May 11, 2018, the contents of which are incorporated by reference here into this application.

### TECHNICAL FIELD

This invention pertains generally to the field of safety equipment and clothing, and more specifically to safety vests which provide enhanced reflective surfaces and lighting, storage for various hydration means, and power and connection means for a range of portable and integrated technologies.

### BACKGROUND

Safety vests have become a standard in personal protection equipment that are worn by individuals in several industries. These workers might be in commercial or heavy highway construction, mining, quarrying, oil/gas extraction industries, flaggers, crossing guards, or a number of other industries where visibility is important. The majority of these vests are made of a nylon material with some reflective material sewn into the vest. The reflective material catches external light, such as from a vehicle's headlights, and becomes much more visible.

In situations when the angle of the vehicle's headlights are not optimum to reflect from the material, however, the vest may not increase the visibility of the worker wearing the vest. When this happens, the driver of such a vehicle may not have enough time to respond or maneuver the vehicle out of the way. With the advent of new lighting technologies, such as light emitting diodes (LED), fiber optics, electroluminescence (EL), EL wire and EL tape, and laser lighting, it is now possible to wear light emitting articles/devices on the vest, thus providing a much longer and wider viewing range than that of reflective materials alone. This greatly increases the visibility of the individual wearing the vest in low light and reduced visibility situations such as foggy weather. These light emitting devices require electricity and wiring to energize them, however.

Individuals who participate in industries where high visibility safety vests are useful and required are frequently on the job at remote sites and/or away from amenities such as power sources useful to recharge the lights in such a vest and/or mobile devices needed for communication, as well as food and water stations, for extended periods of time.

Construction sites are busy and have logistically complex layouts. Worker safety is a paramount concern. Accounting for a worker's location at any given time is critical to be able to identify worker counts in emergency situations and to help site supervision understand where newer more inexperienced workers are located within the project boundaries. Locations and worker identification captured throughout the duration of a project provides project staffing information to project managers and executives regarding day-to-day operations.

The presently disclosed invention aims to provide solutions to the aforementioned problems, and thus provide improved high visibility safety vests that may enhance the safety and work environment of workers in these industries and others.

### SUMMARY

The present invention provides a safety vest with visibility enhancements and optional mobile technology capabilities that may increase worker productivity and safety, and reduce inefficiencies due to downtime. The integrated technology safety vest disclosed herein adheres to the visibility principles regarding reflective surfaces and lighting, and is configured to integrate storage for various hydrations means, and power for several advanced technologies.

According to its major aspects, and briefly stated, the presently disclosed invention includes a high visibility safety vest assembly comprising a vest having a back panel and a front panel joined to the back panel along opposite back panel sides and along left and right shoulder sections, wherein outward facing surfaces of each of the front and back panels comprise at least one band of reflective material and at least one band of lights. At least a portion of the at least one band of reflective material and at least one band of lights may be positioned on each of the left and right shoulder sections. The high visibility safety vest assembly further comprises a power supply configured to provide power to the at least one band of lights, and a control configured to modulate a function of the at least one band of lights. The power supply may provide power via a wired connection, a wireless connection, or both.

According to certain aspects of the present invention, the at least one band of lights may comprise at least one length of LED, EL wire, EL tape, laser wire, or other lighting device. For example, the electroluminescent (EL) lights may comprise at least one length of EL tape, wherein each length of the EL tape may provide luminescence in two opposing directions (e.g., front and back side). According to certain aspects, the EL tape may be a flat EL tape that provides illumination from the top and bottom sides of the tape. According to certain aspects, the EL tape may be flexible and stretchable. According to certain aspects, the EL tape may be heat bondable to the materials of the vest. According to certain aspects, the EL tape may be included on either side of a reflective material, such as left and/or rights sides, and may be attached to the reflective material by stitching or heat bonding. According to certain aspects at least the top side of the EL tape may be reflective. While EL tape has been discussed with regard to these various aspects, the EL tape could be replaced with EL wire, laser wire, or LED lights to achieve the same improved attributes of the safety vest assemblies disclosed herein.

According to certain aspects of the present invention, the safety vest may include at least two pockets, wherein a first pocket of the at least two pockets may be sized and configured for holding a fluid container. Moreover, the first pocket may include a lining of insulating material.

According to certain aspects of the present invention, the safety vest assembly may include a second pocket sized and configured to hold an electronic device, wherein the second pocket may also provide wireless or wired connectivity to the power supply so that the electronic device may be charged. The second pocket may be weather resistant or waterproof.

According to certain aspects of the present invention, the high visibility safety vest assembly may further comprise a vest location device configured to provide a geo-location of the vest. The vest location device may be a global positioning system (GPS), or cellular positioning system (CPS), or wireless internet connectivity, or any combination thereof. Each of the vest location devices may be in electrical communication with the power supply via a wired or wireless connection.

According to certain aspects of the present invention, the high visibility safety vest assembly may further comprise an accelerometer in electrical communication with the power supply.

According to certain aspects of the present invention, the power supply of the high visibility safety vest assembly may be a rechargeable power supply that may be recharged via wired or wireless connection. The assembly may further comprise at least one solar panel positioned on the outward facing surface of one or both of the front panel and the back panel, wherein the at least one solar panel may be configured to supply power to the rechargeable power supply.

According to certain aspects of the present invention, the vest of the high visibility safety vest assembly may include side panels which connect the front and back panels. The side panels may be formed of an elastic material, and may thus provide a conforming fit for the vest. According to certain other aspects of the present invention, the front panel of the vest may comprise two halves, which may be releasably connectable to each other via a connection means such as a zipper, buttons, snaps, hook and loop closure, or a combination thereof.

According to certain aspects of the present invention, the vest may include a front panel and a back panel attached along left and right shoulder sections, and an opening for a user's head centrally located between the left and right shoulder sections. In such an embodiment, the vest may be attached about the user's torso by connecting the front and back panels along left and right sides, such as by ties, buttons, sections of hook and loop closures, zippers, etc.

According to certain aspects of the present invention, the at least one band of lights may be permanently attached to the vest, and may be weather resistant or waterproof and washable. Moreover, the at least one band of lights may be attached to the vest along an edge of the at least one band of reflective material, or may be integrated as part of the at least one band of reflective material. According to certain aspects of the present invention, a surface of the at least one band of lights may include a reflective material. For example, when the light is an EL tape, top or top and bottom surfaces of the tape may comprise reflective materials, such as fabrics and/or coatings.

According to certain aspects of the present invention, the high visibility safety vest assembly may further comprise communication systems, such as wireless communication systems, which may provide communication between the vest and a network and/or between a mobile device and a network. The additional communication system may be in electrical communication with the power source, through either a wired or wireless connection.

According to certain aspects of the present invention, the high visibility safety vest assembly may further comprise an alert system adapted to provide a visual, audible, or tactile alert to a wearer of the vest based on data received via the wireless communications system, wherein the data indicates an alert state (e.g., flashing lights, audible beep or alarm sound, or vibration).

The present invention further relates to a system for worker safety, wherein the system includes any of the high visibility safety vest assemblies detailed hereinabove, and a control system that includes computer-executable instructions (e.g., software program running on a processor) that may provide communication with various technologies on the vest to provide information regarding the vest, and a worker wearing the vest. For example, information may include a geo-location, orientation and/or movements, etc. of the worker wearing the vest.

According to certain aspects of the invention, the computer-executable instructions may be part of a computer program product or platform that may include additional information, for example, the computer program product may be configured to place a geo-location of the vest within a defined boundary that is set-up through geo-mapping or site boundaries. The location device on the vests and/or computer program may have capabilities to communicate with other devices located in machines, equipment, tools, drones, vehicles, and other devices worn by other workers. Additionally, the program product may initiate communication with the vest that may provide information to a wearer of the vest, such as an alert state. According to certain aspects of the invention, the alert state may be communicated as a visual, audible, or tactile signal by an alert system included on the high visibility safety vest assemblies. As such, the vests may have the capability to flash, beep, vibrate, etc. to alert a worker to a potential safety issue, an emergency communication, and/or close proximity to vehicles or other machinery, etc.

### BRIEF DESCRIPTION OF THE DRAWINGS

Aspects, features, benefits and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale.

FIG. 1A illustrates a perspective front view of a person wearing a safety vest in accordance with certain aspects of the presently disclosed invention;

FIG. 1B illustrates the same perspective front view of the safety vest shown in FIG. 1;

FIG. 2 illustrates a front view of the safety vest in accordance with certain aspects of the presently disclosed invention;

FIG. 3 illustrates a back view of a safety vest in accordance with certain aspects of the presently disclosed invention;

FIG. 4 illustrates a right side view of a safety vest in accordance with certain aspects of the presently disclosed invention;

FIG. 5 illustrates a left side view of a safety vest in accordance with certain aspects of the presently disclosed invention;

FIG. 6 illustrates a top view of a safety vest in accordance with certain aspects of the presently disclosed invention;

FIG. 7 illustrates an inside view of a front panel of a safety vest in accordance with certain aspects of the presently disclosed invention; and

FIG. 8 illustrates an inside view of a safety vest in accordance with certain aspects of the presently disclosed invention.

### DETAILED DESCRIPTION

In the following description, the present invention is set forth in the context of various alternative embodiments and implementations involving a safety vest. While the following description discloses numerous exemplary embodiments, the scope of the present patent application is not limited to the disclosed embodiments, but also encompasses combinations of the disclosed embodiments, as well as modifications to the disclosed embodiments.

Various aspects of the safety vest disclosed herein may be illustrated by describing components that are coupled, attached, and/or joined together. As used herein, the terms “coupled”, “attached”, and/or “joined” are interchangeably recited to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the safety vest disclosed herein may be described and illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

Relative terms such as “lower” or “bottom” and “upper” or “top” may be used herein to describe one element's relationship to another element illustrated in the drawings. It will be understood that relative terms are intended to encompass different orientations of aspects of the safety vest in addition to the orientation depicted in the drawings. By way of example, if aspects of the safety vest in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing. Terms used to refer to a specific portion of the safety vest, however, should be taken to encompass only that portion of the safety vest. As such, reference to a “front” panel of the safety vest is a reference to only that portion of the safety vest, and would not encompass a “back” panel thereof.

It must also be noted that as used herein and in the appended claims, the singular forms “a”, “an”, and “the” include the plural reference unless the context clearly dictates otherwise. Thus, reference to “a” material, “a” light, “an” outlet, or “the” pocket, may be a reference to one or more of these or any other component as disclosed herein.

Unless defined otherwise, all technical and scientific terms used herein have the same meanings as commonly understood by one of ordinary skill in the art.

The present invention relates to a technologically advanced high visibility safety vest assembly that provides increased safety and productivity for the worker. The assembly generally includes a vest adapted to cover a human torso that offers a comfortable fit along with integrated features to provide lighting, power for the lighting, and a hydration component. As such, the high visibility safety vest assembly provides enhanced visibility for workers in a range of limited visibility conditions while serving as a tool that may have various technologies integrated therein.

The safety vest assembly comprises a flexible high visibility material with reflective bands and lighting bands attached thereto. Lighting and circuitry included within the vest may be flexible and may connect a control switch to the lights. The circuitry and lights may be controlled (e.g., when the lights are activated, whether the lights flash, and/or the color and intensity of the lights) on each individual vest by the user, based on their knowledge and/or current visibility factors.

The lights may be included on a surface of the vest, such as near the reflective materials. For example, the lights may outline the sides of the reflective material on the front and the back of the vest for maximum visibility. According to certain aspects, the lights may be a part of the reflective material. The vest may include a port for connection of a power supply, and/or may also include the power supply which may power the at least one band of lights and optional additional technologies such as accelerometers, GPS or CPS, body cameras, radio receivers and/or transceivers, and alert devices.

Various pockets may be included on the vest to provide storage for any of a hydration bottle, food items, mobile devices, the power supply, and the additional optional technologies.

The various combinations of lighting, pockets for food and water, GPS or cellular and accelerometers, safety alert system, and portable powering along with other various important features of the high visibility safety vest assembly form this disclosure.

The term “vest” is hereby defined to include any article of clothing that is worn on the human torso, and thus may include vests, jackets, coats, tool or construction vests, rain-clothes, and other related clothing.

The vest of the safety vest assembly may include a front panel and a back panel. The front and back panels may be joined along opposing sides (e.g., from a region below a wearers armpit to their waist) and along top edges or regions (e.g., at the shoulder). The front and back panels may be permanently joined (e.g., sewn together, formed of one piece) or may be releasably joined, such as by first and second mating strips. For example, the first and second mating strips may comprise hook and loop closures (e.g., Velcro®), hook and eye closures, zipper(s), buttons, or snap closures.

The front panel may include two panel halves. The two panel halves may be releasably attachable to one another at a central point on the vest. The releasable attachment of the two halves of the front panel may be via first and second mating strips comprising hook and loop fasteners, respectively. The releasable attachment of the two halves of the front panel may be via a hook and loop closures, a zipper, buttons, snaps, hook and eye closures, or any other means known in the art.

The front and back panels may be formed of any material known in the art. For example, the vest may be formed of textile material, synthetic material, or some like flexible composition. Additionally, the vest may be formed of a mesh type material comprising a natural or synthetic composition such as, for example, a light-weight polyester mesh. The material may be washable. The material of the front and back panels may be brightly colored to enhance visibility. For example, the material of the front and back panels may be bright yellow, red, orange, or lime green in color.

Attachment of the front and back panels along the side edges may be via side panels. The side panels may be formed of the same material as the front and back panels, or of a different material such as, for example, an elastic material allowing for a conforming fit. The material of the side panels may be washable. Moreover, the material of the side panels may be brightly colored to enhance visibility, such as bright yellow, red, orange, or lime green. According to certain aspects of the present invention, the materials selected may comply with ANSI 107 regulations. For example, the colors selected for background and combined-performance materials may include fluorescent yellow-green, fluorescent orange-red, fluorescent red.

Each of the front and back panels of the vest of the safety vest assembly may have reflective or retro-reflective sections or bands formed of reflective or retro-reflective materials, respectively. These sections may extend around the vest, may connect between the front and back panels of the vest, and/or may include the side panels of the vest. Further, the region at the shoulder of the vest may include these sections or bands.

The reflective materials of the reflective sections or bands may comprise separate or separable reflective materials, or may comprise reflective coatings on the material of the front, back, and/or side panels. As used herein, the term “reflective” may be taken to include any material or coating that reflects light out in different directions, depending on the angle of entrance. The retro-reflective materials of the retro-reflective sections or bands may also comprise separate or separable materials. As used herein, the term “retro-reflective” may be taken to mean any material that reflects light back in the same direction in which it entered. In general, and in compliance with ANSI 107 requirements, the presently disclosed safety vests will include at least one section or band of retro-reflective material thereon, such as in the shoulder area of the vest.

Retro-reflective materials may include tapes or bands of fabric (applique), or coatings. Exemplary retro-reflective materials include reflective glass beads or prismatic or micro-prismatic structures that can improve the reflectivity of incoming light. The retro-reflective materials may return light back to a light source, such as automobile headlamps, along the same light direction or substantially the same direction as provided by the light source.

The materials used to form the front, back, and side panels of the vest may be fire retardant or fire resistant. Moreover, the materials used to form the reflective or retro-reflective sections or bands of the vest may be fire retardant or fire resistant. Such may be achieved by a specific material selection such as, for example, a fire retardant ceramic material, or may be achieved by use of a fire retardant coating applied to the material(s) of the vest, and may meet with OSHA and/or ANSI standards in any given industry for protective gear (e.g., construction, mining, etc.).

The International Safety Equipment Assocation (ISEA) in conjunction with the American National Standards Institute, Inc. (ANSI) published the first American National Standard for high-visibility safety apparel in 1999. Garments complying with ANSUISEA 107-1999 quickly became widely accepted as the best way to protect workers against hazards of low visibility. These standards have recently been updated (2010, 2015). The presently disclosed vest may be configured to comply with standards defined in ANSI 107, such as in ANSUISEA-107 2010 and/or ANSUISEA 107-2015.

The safety vest assembly further comprises and at least one band of lights. The lights may be included along any portion of the exterior surfaces of the front, back, and/or side panels of the vest. It is contemplated that the at least one band of lights may be included on one or more edges of the reflective or retro-reflective band(s). The band of lights may also have the reflective material integrated so that the reflective area becomes the lighting area.

The safety vest assembly may include a plurality of bands of lights, wherein each band of lights may comprise multiple individual lighted elements such as LED's or LED neon; or may include individual lengths of lighting elements such as LED or LED neon, laser wire, or fiber optic; or may be generated by a single element such as electroluminescent (EL) wire or tape, or an electroluminescent tape, such as Vynel™, produced by Ellumiglow out of Portland, Oreg. While lighting elements have been discussed as multiple elements, or lengths of one or more elements, it should be understood that use of the term “length” may indicated that the lights are grouped so that a single electrical connection may power the light(s) within that group. Each band of lights may be configured to generate any number of different colors of light or varying intensities of light, at the same or at varying times. Moreover, each band of lights may also perform any type of lighting effect such as remaining illuminated, flashing, and/or performing a unique or synchronized chasing pattern.

Additional features may be included on the at least one band of lights. For example, a coating may be applied over the at least one band of lights in a defined area that may provide information regarding the vest or the wearer of the vest (e.g., rank, trade category, company name or logo, etc.). For example, a black lettering indicating a workers name and/or rank (e.g., foreman) may be applied over the at least one band of lights. During daylight hours the lettering would be easily readable, and during night hours, light from the at least one band of lights would be blocked by the lettering so that the lettering would be easily readable.

In preferred embodiments, the lighting may be provided by laser wire or EL tape. For example, the bands of lights may comprise at least one length of EL lights, where each length may be a flexible strip of EL tape, such as Vynel™. The at least one length of EL lights may be flat, or may have a non-flat shape, such as a domed, pyramidal, or square shape. The at least one length of EL lights may include a covering or may incorporate reflective materials. Moreover, the at least one length of EL lights may provide luminescence from more than one side, such as from a top side and a bottom side when the EL lights are configured as a tape. In this way, the light would also illuminate an inside of the vest (i.e., light would be visible through the material of the vest on an inside of the vest).

According to certain aspects, the EL tape may be flexible and stretchable. The EL tape may be heat bondable to the materials of the vest. According to certain aspects, the EL tape may be included on either side of a reflective material, such as left and/or rights sides, and may be attached to the reflective material by stitching or heat bonding. According to certain aspects at least the top side of the EL tape may be reflective. According to certain aspect, the EL tape may be washable.

Although described above as including bands of lights, this is but one possible implementation, as other embodiments are contemplated wherein individual lighted elements can be disposed along or within the vest that may not be tied directly to a band of lights. Moreover, the lighting elements are not limited to the use of lighting elements detailed above (e.g., LED's, laser wire, fiber optic, EL tape, etc.) as any type of device capable of generating light as known in the art can also be utilized.

The safety vest assembly may include pockets useful for a variety of purposes such as, for example, pockets configured to hold mobile devices, writing instruments, identification cards, or even drink containers. Certain of these pockets may be located on an inside surface of the vest, and certain of these pockets may be located on an outside surface of the vest. For example, the vest may include a pocket on an inside surface of a front panel configured to hold a mobile device, as discussed above. Such a pocket may include a waterproof or weather resistant lining and integrated power to allow for the powering of the mobile device. The waterproof or weather resistant lining may be clear or transparent to allow the user to view the items stored therein.

Certain other pockets may be configured to hold a drink container or bottle, and may include an insulated lining that may hold a cold or hot beverage at a temperature that is lower or higher than ambient, respectively, for an extended period of time. Such pockets may be further configured to store food items.

Certain of the pockets may be configured to directly contain a liquid and may also provide a drinking port or straw (e.g., an integrated hydration pouch). As such, some of the pockets may be configured to be attached/detached from the vest, such as for cleaning the vest and/or the pocket interior.

Certain pockets may be configured to hold work tools useful to the vest wearer while on the job site such as, for example, writing utensils, pagers or other communication devices, identification or payment cards, small work utensils (e.g., screw drivers, tape measures, etc.).

The safety vest assembly may further include clips or attachment points which may provide for connection of additional devices such as, for example, electronic devices, hydration devices, keys, identification cards, etc. Exemplary attachment points include loops, hooks, D-rings, and any other attachment means known in the art.

The at least one band of lights on the vest may be supplied with power from a power supply. According to certain aspects of the present invention, the safety vest assembly may include a power supply configured to provide power for the various lighting and technology components. The power supply may be sized and configured to meet the energy demands of equipment incorporated into, or otherwise used with, the vest. It is contemplated that the power supply be configured such that it is capable of accepting a charge current, and upon depletion of the charge, the power supply may be recharged. It is further contemplated that the power supply may be charged from more than one energy source. The power supply may be one unit or may comprise several units.

The vest may include a power supply, such as rechargeable and/or replaceable batteries, positioned in a weather resistant or waterproof pocket on the vest. For example, the power supply may be included in a waterproof or weather resistant pocket on an inside or outside surface of the back panel of the vest. The vest may also include electrical circuitry to provide electrical connection between the power supply and the at least one band of lights, and optional additional technologies, such as accelerometers, GPS or CPS, body cameras, radio receivers and/or transceivers, and alert devices. According to certain other aspects of the present invention, the electrical connection between the power supply and the at least one band of lights and/or optional additional technologies may be wireless.

According to certain aspects of the present invention, the vest may include a first port for connection of the power supply, wherein the first port is configured so that connection of the power supply may provide power to the at least one band of lights and optional additional technologies. According to certain aspects of the present invention, the first port may be positioned within or adjacent to a weather resistant or waterproof pocket on the front or the back of the vest, wherein the weather resistant or waterproof pocket may be sized and configured to accept a power supply connectable to the first port.

The vest may also include electrical circuitry so that connection of a power supply to the first port may provide power to the additional technologies, and may also provide power to external devices such as a mobile phone, tablet, radio, etc. The first port may be wired, and/or may provide wireless connectivity and/or charging for a mobile or electronic device. This may allow the worker to be mobile within the environment while providing power for these external devices (e.g., phones or tablets, etc.). The power of the power supply can be rechargeable, such as on a daily basis, and/or continuously.

The power supply may be charged by several different energy sources. For example, the safety vest assembly may be connectable to an external power supply. In this manner the external power supply may charge the power supply. The external power supply may be an AC current from a wall outlet, wireless charging station and/or a flexible solar panel attachable to an external surface of the safety vest. For example, the external power supply may provide the power supply with a full charge, and as the charge depletes from the power supply, the solar panel may recharge the power supply to prolong the charge.

The power supply may be a battery such as, for example, a 9-volt battery, a lithium ion battery or lithium ceramic battery, the latter of which is also flexible, free of liquids, and flat. However, it should be understood that the power supply may take any form in which electrical energy may be stored and/or recharged.

According to certain embodiments of the present invention, the safety vest assembly may include the power supply. According to other embodiments of the present invention, the safety vest assembly may not include the power supply, and a user of the vest may need to provide the power supply. The power supply may be attached to the vest via the first port. The first port may be a unique or known connection for a power supply. For example, the first port may be configured as a wired connection, or if the vest is powered by 9 volt batteries, the first port may be the contact points for attachment of the battery.

The safety vest assembly may further comprise a control, wherein the control may be a switch that may be manually operated. For example, the switch may have an off position for the at least one band of lights, an on position for the at least one band of lights, and/or one or more flash positions for the at least one band of lights. The switch may further include a position which provides change or selection of the color for the lights. According to certain embodiments of the present invention, the control may include more than one switch to accomplish these various functions (e.g., one for each of on-off, color selection, and flash pattern). The switch(es) may be part of the power supply, or may be a separate component(s) included at a location other than the power supply, such as on a front portion of the vest that is easily accessible by the worker wearing the vest.

As can be appreciated, an electrical circuitry may provide electrical connection between the power supply (e.g., batteries), the on/off switch and any other switches, and the one or more bands of light. The control may be included in the electrical circuit such that the power supply provides power to the bands of lights and the on/off switch and other switches when included, and the control may be used to operate the various lighting functions of the at least one band of lights.

Selection of the flash pattern and color of lights may depend on factors such as the lighting conditions and/or weather conditions. Moreover, selection of the color of the lights may depend on a status of a user wearing the presently disclosed vests. For example, foremen or veteran workers may display a different color than new workers, or workers from different trades on a single job site, or different works shifts, may display different colors.

The safety vest assembly may further include a second port configured to provide a source of power to a portable electronic device such as, for example, a mobile phone, an MP3 player, a pager, a walkie-talkie, a radio, an environmental sensor apparatus, a health monitor, and the like. The switch, which is part of the control, may further comprise an on position for the second port and an off position for the second port. As above, this switch may be included on the power supply, or may be included at a position distal from the power supply such as near the second port.

The second port may link the user's portable electronic device to the power supply. As such, the power supply may include a unique inverter that may allow the power supply to provide power to the at least one band of lights and to the portable electronic device.

The second port may be located in a pocket. For example, the second port may be located in a pocket that is waterproof or weather resistant, and/or on an inside surface of the vest, such as an inside surface of a front panel of the vest (e.g., the pocket configured to hold a mobile device). According to certain aspects of the present invention, the vest may include more than one second port in more than one location, such as near an internal or external attachment point on the vest (e.g., near a loop or D-ring on the outside front of the vest).

According to certain aspects of the present invention, the second port may include an extendable cord that may allow the electronic device to be attached to the power supply while the user is holding or using the device, or to allow the electronic device to be attached on the interior or exterior of the vest such as hooked on one of the attachment points (e.g., attached distal from the pocket with the power port therein). The extendable power cord may be stored in a specialized pocket, or may be extendable and retractable into a slot of the second port location. According to other aspects of the present invention, the second port may include a wireless charging contact or region that may allow the electronic devise to be charge or powered wirelessly.

The safety vest assembly may further comprise a communication system, such as an integrated global positioning system (GPS), cellular positioning system (CPS), wireless technologies and/or any combination of such communication systems. For example, the safety vest assembly may include a GPS/CPS which generates a positioning signal including the wearer's location and specific information of the wearer. In such a case, personnel monitoring the wearer may track the position of the wearer in real-time by receiving signals from the GPS/CPS.

Cellular clients, for example, may utilize cellular networks to enable users to pedal''t location tracking. Cellular technology included in the vest, or via a cellular phone carried by a wearer of the vest, may utilize a cell network to send and receive data by a transceiver (radio) physically coupled to the vest/cellphone.

Moreover, the safety vest assembly may include a wireless interface that may provide communication between a user's mobile device and a local area network or other communication network. In this way, when a user is at a job site that may be remote and may not have sufficient mobile communications networks (e.g., LTE networks, etc.), or when a user wishes to use electronic communications from a device that is not on a mobile communications network, the wireless interface may provide a means to contact a local area network.

The safety vest assembly may interact with additional software utilities via the user's mobile device, or directly via a wireless communication device incorporated within the vest, to participate in communications with other devices, such as vehicles, equipment, tools, machines, drones, and other devices such as vests of other workers on a site. Thus, the vest may become part of an Internet of Things (IoT) geo-locations software management utility via a communications network.

The safety vest may include an accelerometer, which may be attached within a portion of the vest, or positioned/carried in a pocket of the vest. The accelerometer may be in electrical communication with the power supply via the circuitry. The accelerometer may provide information about a position or motion of the vest, such as a wearer of the vest.

The circuitry that may provide power from the power supply to the various bands of lighting, the second port, the GPS/CPS and any wireless interface, the accelerometer, etc., may be embedded within the material of the vest. The embedded circuity may be flexible and allow movement with the body.

This circuitry may be able to withstand extreme environmental conditions, such as exposure to heat and cold, and/or exposure to winds, rain, and snow. Moreover, the circuitry may be able to withstand washing and drying of the vest. The reflective and/or retro-reflective materials, and the bands of lighting may also be able to withstand extreme environmental conditions, and/or washing and drying of the vest.

Various numbers of all of the components which may provide and/or require power (e.g., power pack, electronic circuitry, bands of lighting, wireless interface, GPS/CPS, power port, accelerometer) may also be provided in waterproof compartments or pouches on the vest. For example, the accelerometer, certain lights, power supply, etc.

Moreover, these components may be configured to be detachable from the vest. For example, the power supply or certain of the lights may be included in pouches (waterproof or otherwise) that are detachable and re-attachable, such as by hook and loop attachment, snaps, buttons, zippers, etc. to the vest. As another example, all of the components which may provide and/or require power may be included in waterproof and/or detachable pouches. Thus, when the vest requires cleaning, each of these components may be detached from the vest and washed (i.e., wiped clean) while the vest itself may be washed by any standard means known in the art.

According to certain aspects of the present invention, the power supply may enable wireless powering of some or all of the various components included as part of the vest. As such, the vest may be configured with an electrical circuitry that connects the power supply to only those elements which may not be wirelessly powered, or may be configured without an electrical circuitry, respectively.

The high visibility safety vest assembly may be part of a system that includes a control system such as a software product, wherein the control system is configured to receive and process data from one or more of the various integrated technologies of the high visibility safety vest. The control system may enable location tracking of wearers of the vest via communication with GPS/CPS or wireless technologies included in the vest. The location tracking may be provided in real-time, and may be mapped to a geo-location or to a user provided map, such as a map of a work site.

The control system may further enable tracking of motion and position or orientation (standing, lying down, etc.) of the wearer of the vest via communication with an accelerometer included on the vest. This may provide data regarding at least work output and wearer health (i.e., data from the accelerometer may signal a problem or accident based on specific motions or lack of motions), among others. This information can also be communicated to other vehicles, equipment, tools, drones, machines and other devices on workers, such as to indicate an alert state to other workers in the vicinity.

The control system may further enable communication with an alert system of the vest, wherein the alert system on the vest may include a visual, audible, or tactile alert signal. For example, a speaker or buzzer may be included on the vest that may be trigger to produce an audible alert by the control system to warn the wearer of the vest of an emergency, or other event status. The vest may additionally or alternatively include a small motor capable of producing a vibration that may produce a tactile signal when triggered by the control system.

Each of these functionalities may be enabled on the vest by inclusion of a communications device, such as a wireless communications device, that may send and/or receive data from the control system. According to certain aspects of the present invention, the communication device may be a mobile electronic device, such as a cell phone, provided by the wearer of the vest, or may be a separate electronic component incorporated in the vest.

The control system may be provided on a computing device which may comprise at least one processor configured to execute computer-executable instructions, a memory storing the computer-executable instructions configured to receive information from the various integrated technologies on the vests, and a database configured to store the information received from the at least one safety vest assembly. For example, the control system may receive location information from a vest indicating a location of the vest, and use that information to calculate a geolocation of the vest, or a position of the vest within a mapped area (construction site boundaries). Data received as a function of time may be used to map a workers movements.

Implementations of the control system are described within the context of a device configured to perform various steps, methods, and/or functionality in accordance with aspects of the described subject matter. It is to be appreciated that a control system including a computing device or computer system can be implemented by one or more computing devices. Implementations of the control system can be described in the context of a “device configured to”, wherein the term configured may be taken to mean that the device can implement computer-executable instructions that are executed to perform various steps, methods, and/or functionality in accordance with aspects of the described subject matter.

In general, a computer system or computing device can include one or more processors and storage devices (e.g., memory and disk drives) as well as various input devices, output devices, communication interfaces, and/or other types of devices. A computer system or computing device can also include a combination of hardware and software. It should be appreciated that various types of computer-readable storage media can be part of a computer system or computing device. As used herein, the terms “memory”, “computer-readable storage media” and “computer-readable storage medium” do not mean and unequivocally exclude a propagated signal, a modulated data signal, a carrier wave, or any other type of transitory computer-readable medium. In various implementations, the control system may include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

The control system can implement and utilize one or more program modules. Generally, program modules include routines, programs, objects, components, data structures, etc., that perform particular tasks or implement particular abstract data types.

The control system can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules can be located in both local and remote computer storage media including media storage devices. Still further, the aforementioned instructions can be implemented, in part or in whole, as hardware logic circuits, which can include a processor.

The control system can be implemented by one or more computing devices such as computers, PCs, server computers configured to provide various types of services and/or data stores in accordance with aspects of the described subject matter. Exemplary sever computers can include, without limitation: web servers, front end servers, application servers, database servers, domain controllers, domain name servers, directory servers, and/or other suitable computers.

Components of the control system can be implemented by software, hardware, firmware or a combination thereof. For example, the control system can include components implemented by computer-executable instructions that are stored on one or more computer-readable storage media and that are executed to perform various steps, methods, and/or functionality in accordance with aspects of the described subject matter.

The control system can include a controller, memory, additional hardware storage, input devices, and output devices. Input devices can include one or more of the exemplary input devices described above and/or other type of input mechanism and/or device. Output devices can include one or more of the exemplary output devices described above and/or other type of output mechanism and/or device.

The control system can contain one or more communication interfaces that allow the control system to communicate with other computing devices and/or other computer systems. The control system can include and/or run one or more computer programs implemented, for example, by software, firmware, hardware, logic, and/or circuitry of the control system. Computer programs can include an operating system implemented, for example, by one or more exemplary operating systems described above and/or other type of operating system suitable for running on computing device. Computer programs can include one or more applications.

The general purpose of the safety vest assembly provided herein is to provide an enhanced high visibility safety vest which has many mobile technology and additional visibility features that result in an improved flexible lighted safety vest that allows for mobility and connectivity. There are additional features of the disclosure that will be described in the specific example provided below.

### EXAMPLE

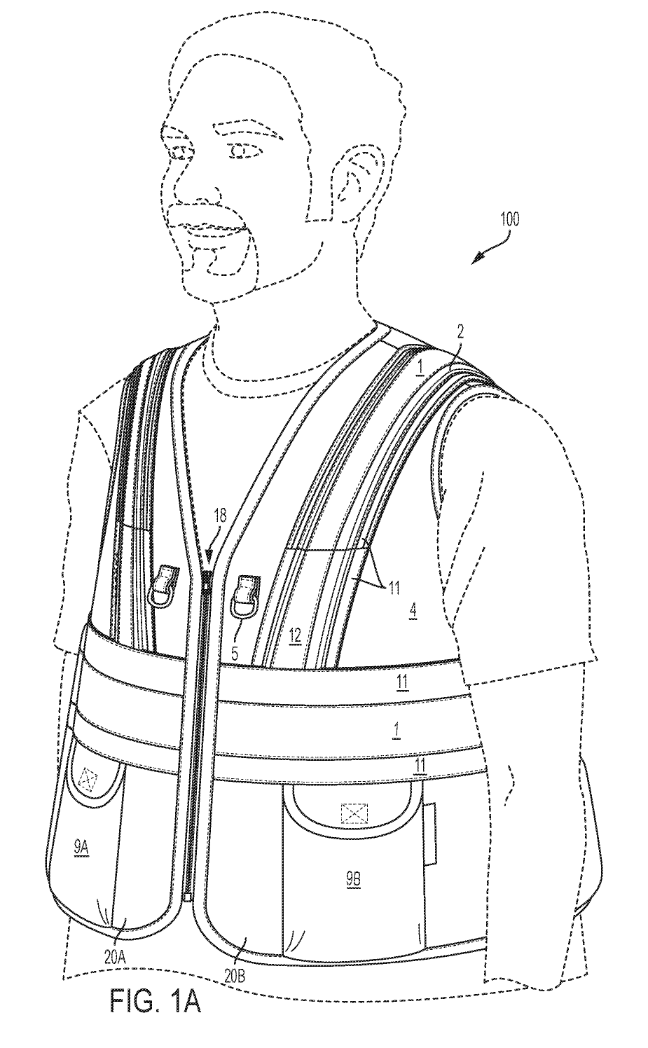

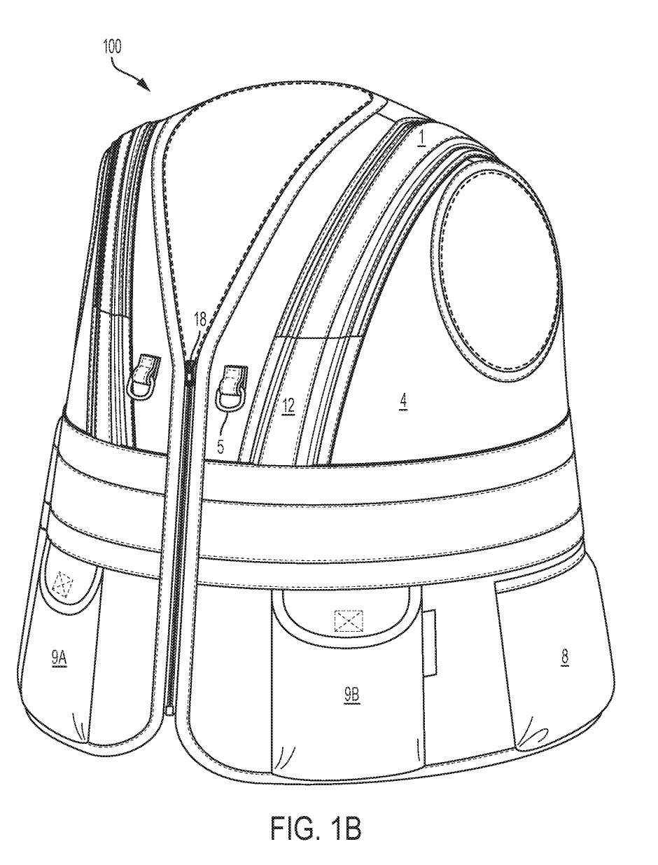

With reference to the drawings, FIGS. 1-8, the concepts and principles of the presently disclosed safety vest assembly will be described for a specific embodiment. While this embodiment is detailed to enhance an understanding of the present invention, the scope of the present patent application is not limited to this disclosed embodiment, but also encompasses combinations, as well as modifications as detailed hereinabove, to this disclosed embodiment.

FIG. 1A illustrates a front perspective view of a person wearing a high visibility safety vest assembly 100 according to the presently disclosed invention. The vest generally includes front and back panels connected along sides (i.e., from a region below a wearer's armpit to the wearer's waist) and along a top region (i.e., at the wearer's shoulders). The front panel may be divided into right 20A and left 20B panels that may be releasably connected via a closure mechanism 18, such as a zipper.

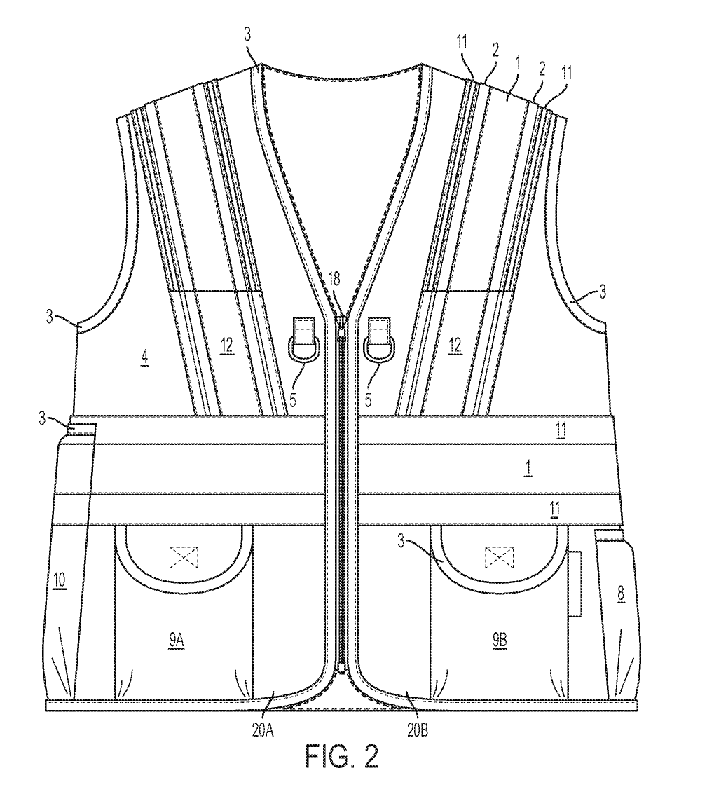

With reference to FIGS. 1A, 1B, and 2 the vest may include bands of reflective material 1 on a front side, such as retro-reflective material, which are outlined by one or more bands of lights 2. The bands of lights 2, such as flexible strips of continuous LED, fiber optic, or laser lights, outline the reflective regions 1 on the front of the vest. These bands of lights 2 provide the safety vest with sufficient lighting to allow the vest to be highly visible, and may be bright enough to provide sufficient illumination to assist the wearer in viewing the local area when in the dark. The reflective material bands 1 may be outlined by additional bands of brightly colored or reflective materials 11.

The bands of lights 2 may be controlled by a control switch (e.g., push button) placed anywhere on the vest, such as on the front of the vest or on the power supply, that allows the user to turn the bands of lights on with continuous or blinking illumination or power them off.

The main body portion 4 of the vest, and optionally various pockets (e.g., pockets on the front 9A, 9B, 12), may be made of materials having colors that are easily visible, which may be ANSUISEA 107 compliant (e.g., ANSUISEA 107-2015). Additional differently colored materials, or additional reflective beading materials (3) may be included at the user's neck, waist, and shoulders in the cut-out areas of the vest. In compliance with the ANSUISEA 107 standards, retro-reflective material 1 may be included at the top of the shoulder region of the vest to allow for visibility from above.

Various connection points 5 may be included, such as the D-rings. These connection points may be located at the chest on either or both of the front panels 20A and 20B to allow for connections of various devices, such as mobile tablets or various tools, thus allowing the worker to have hands free ability.

Pockets 12 for writing utensils or small tools, or for mobile electronic devices, may be included. In the figures, these are shown to be located along the top of one of the reflective bands 1, wherein instruments to be securely stored may be easily accessed for performing tasks. An insulated side pocket (8 and/or 10, see FIG. 2) may also be provided, and may allow for beverages to be stored. These pockets may be open as shown, and may include an elastic region near the top to hold a top edge of the pocket in close proximity to the vest, may include no elastic, may include a flap, and/or may be fastened to a closed state, such as by hook and loop closure (Velcro®), a button, zipper, or the like.

Front pockets (9A, 9B) may be included, and may provide additional storage for the user. These pockets may be open (no closure or flap), may include a flap as shown, and may be fastened to a closed state, such as by hook and loop closure (Velcro®), a button, zipper, or the like. While a specific number, size, and configuration (position on vest, shape, closure mechanism, material, etc.) of pockets is shown in the figures, additional or fewer pockets may be included, and various other sizes and configurations of pockets may be included.

Any or all of the pockets (8, 9A, 9B, 10, and 12) may include reflective or retro-reflective material along a portion of the pocket, such as the top portion (e.g., pocket 10) or edge (beading 3), or along the total region of the pocket (e.g., pocket 12). For example, front pockets 12 are shown in FIG. 1 to have retro-reflective material 1 and additional brightly colored or reflective materials 11 included along a front of the pockets.

Not shown in the figures are specific locations for additional technologies that may be included on the vest. For example, a vest location device such as a GPS, or an accelerometer, or the wireless data communication system. In general, each of such components could be positioned on the vest in a waterproof or weather resistant pocket, such as a pocket having a weather resistant or weather proof lining, on an inside or outside of the vest.

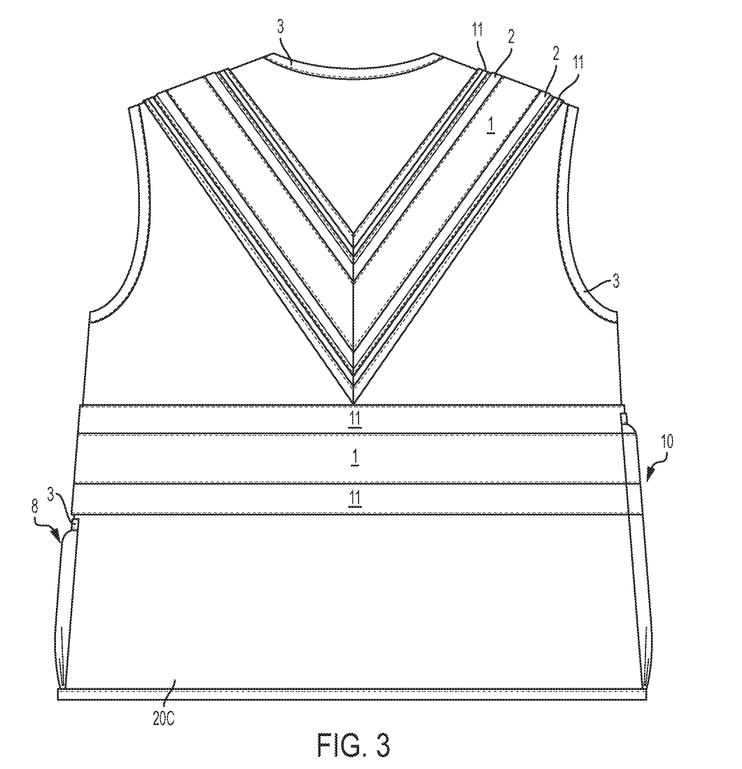

As shown in FIG. 2, the front of the vest may include bands of reflective material 1 outlined by additional bands of brightly colored or reflective materials 11 at a midsection of the vest. FIG. 3 illustrates a back view of the vest. As shown, the bands of reflective materials 1 and/or lights 2 may wrap around the vest from the front (panels 20A and 20B) to the back 20C. For example, the bands at the midsection of the vest that include the reflective material 1 having borders of brightly colored or reflective materials 11 wrap front the front of the vest to the back, including side portions of the vest, and may also include the pockets (i.e., pocket 10). Moreover, the bands of reflective materials 1, lights 2, and additional borders of brightly colored or reflective materials 11 that run vertically on the front of the vest may wrap over a shoulder portion of the vest to form a “V” shape on the back of the vest.

In certain cases, the vest may include additional clothing features, such as a detachable collar that may be included to provide UV protection for the user's head from the sun.

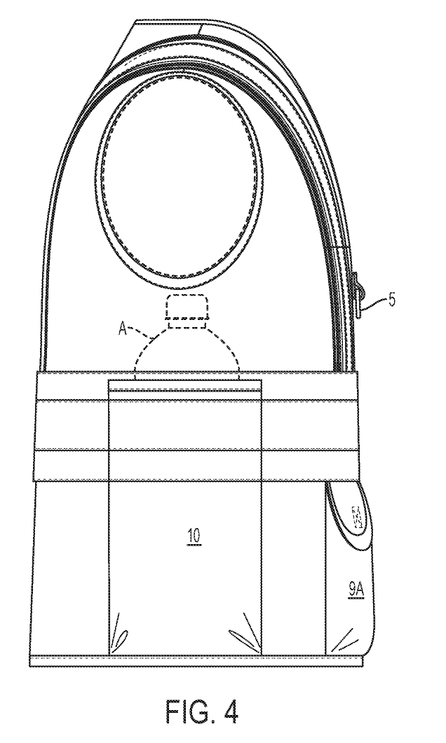

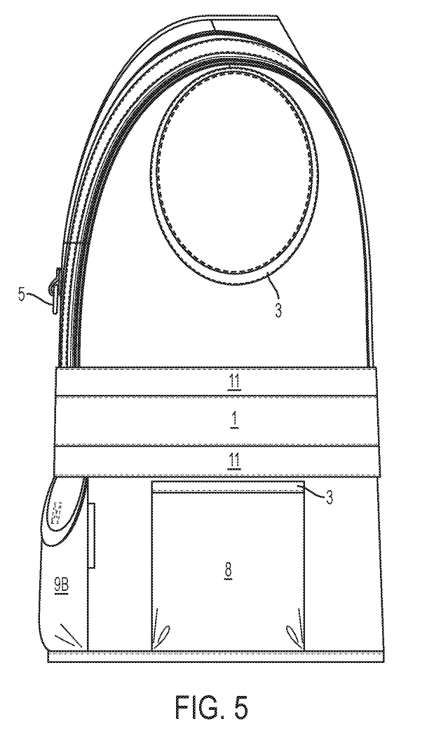

FIGS. 4 and 5 show right and left side views of the vest, respectively. In FIG. 4, a water bottle A is shown positioned in the side pocket 10. This side pocket may include additional lining materials, such as an insulated lining material.

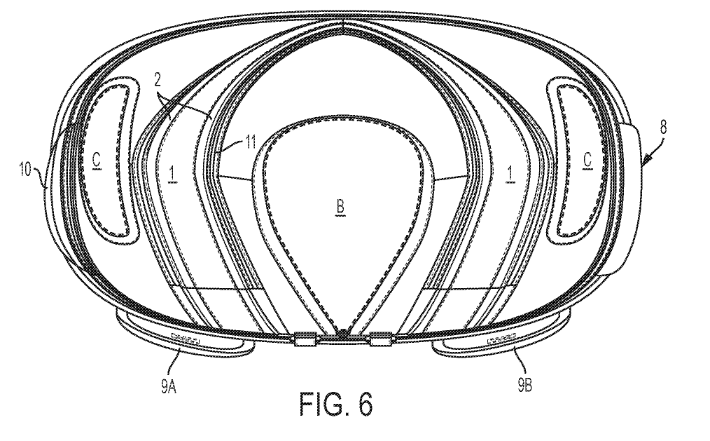

FIG. 6 shows a top view of the vest, indicating an opening B configured for a wearer's neck, and openings C configured for the wearer's arms. Also shown are the bands of reflective materials 1, lights 2, and additional borders of brightly colored or reflective materials 11 that run vertically on the front of the vest and wrap over the shoulder portions of the vest.

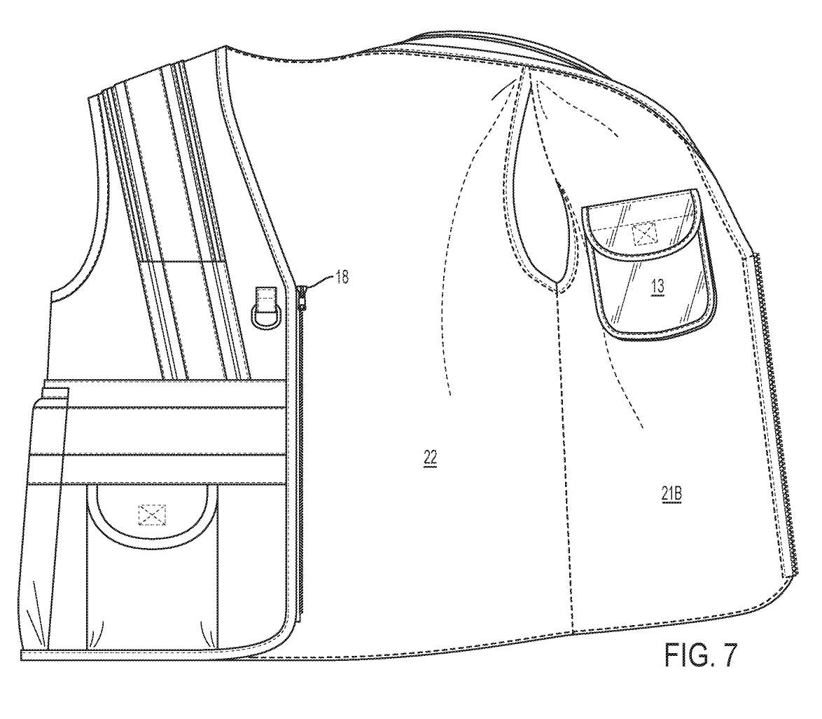

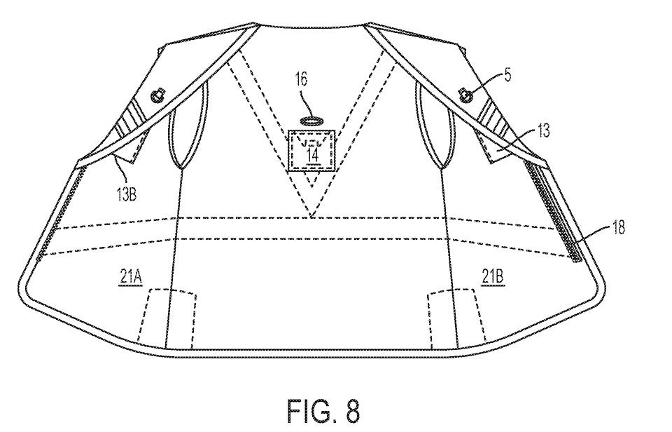

A power supply, such as rechargeable batteries, may be positioned in an inside pocket, such as pocket 13 shown in FIG. 7 and/or pocket 14 shown in FIG. 8. A control switch may also be located as part of the power supply, and the pockets may include an access point (e.g., hole) so that a person wearing the vest may access the switch. Alternatively, a control switch may be positioned separately from the power supply, such as in the inside of the vest 22. The inside pocket 14 may be waterproof or weather resistant, such as by inclusion of a weather resistant or waterproof lining and a top closure (Velcro®, zipper, zip-lock style closure, etc.). Either or both of the power supply and/or the pocket in which the power supply reside may be removed to recharge as needed (e.g., pocket may include attachment means such as Velcro® so that it is removably attachable to a position on the vest). Alternatively, the power supply may be recharged wirelessly. Additionally, either or both may be removed to wash the vest as needed.

The circuitry which connects the power pack to the various lighting and power ports feeds from this power supply. For example, circuitry may be included which connects the power supply in pocket 14 to the bands of lights 2, and the power port used to charge a smart phone in pocket 13. Moreover, a weather and water resistant clear pocket 13 on an inner left side of the vest 21A may be included which may provide storage of a mobile smart device where the device can be easily seen and charged providing increased productivity of the worker and allowing for mobility. This pocket may include a power port for charging the electronic device. The vest may also include a buttonhole 16 on the back of the vest which may allow for passage of external wiring, such as charging cables/cords or headphone cables/cords.

FIG. 8 illustrates an inside view of the vest. A pocket 13 may be included on the inside front left panel 21B, and/or a pocket 13B may be included on the inside front right panel 21A of the vest. Reflective material 1 and light bands (e.g., embedded LED lights) 2 allow for high visibility of the user from all angles and sides. As indicated above, the bands of lights may be flat tapes of EL lights that illuminate from both the top and bottom sides of the tape. As such, the lights may illuminate an inside of the vest.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A safety vest assembly comprising:
a vest comprising:
a back panel and a front panel, wherein the front panel is joined to the back panel along opposite back panel sides and along left and right shoulder sections, wherein outward facing surfaces of each of the back panel and the front panel comprise at least one band of reflective material and at least one band of lights, and
at least two pockets, wherein a first of the at least two pockets is sized and configured for holding a fluid container;
a first power port configured for connection of a power supply that supplies power to at least the band of lights via an electrical circuitry included within the vest; and
a control configured to modulate a function of the at least one band of lights and the power supply.

2. The safety vest assembly of claim 1, wherein the at least one band of lights comprises at least one length of electroluminescent (EL) lights, wherein each length of EL lights provides luminescence in two opposing directions.

3. The safety vest assembly of claim 1, wherein the first of the at least two pockets comprises a lining of insulting material.

4. The safety vest of claim 1, further comprising a power supply connectable with the electrical circuitry of the vest via the first power port.

5. The safety vest assembly of claim 1, further comprising:
a second power port configured to provide power to an electronic device, wherein the second power port is in electrical communication with the power supply, and provides power to the electronic device via a wired connection, a wireless connection, or both.

6. The safety vest assembly of claim 5, wherein a second of the at least two pockets is positioned on an inner surface of the front panel and is sized and configured to accept the electronic device.

7. The safety vest assembly of claim 4, wherein the power supply is a rechargeable power supply, wherein recharging is via a wired connection, wireless connection, or both.

8. The safety vest assembly of claim 1, further comprising:
a vest location device to provide a geo-location of the safety vest assembly.

9. The safety vest assembly of claim 8, wherein the vest location device comprises a global positioning system or a cellular positioning system in electrical communication with the power supply.

10. The safety vest of claim 1, further comprising:
an accelerometer in electrical communication with the first power port; and
a wireless data communications system configured to wirelessly communicate data received from the accelerometer with an external data communications system.

11. The safety vest assembly of claim 1, further comprising:
at least one solar panel positioned on the outward facing surface of one or both of the front panel and the back panel, wherein the at least one solar panel is configured to supply power to the power supply.

12. The safety vest assembly of claim 1, wherein the at least one band of lights is attached to the vest along an edge of the at least one band of reflective material, or is integrated as part of the at least one band of reflective material.

13. The safety vest assembly of claim 1, wherein the control is a switch providing an off condition for the at least one band of lights, an on condition for the at least one band of lights, a flash condition for the at least one band of lights, or any combination thereof.

14. The safety vest assembly of claim 1, further comprising:
a wireless data communications system configured to receive data from an external data communications system;
an alert system adapted to provide a visual, audible, or tactile alert to a wearer of the vest based on data received via the wireless communications system, wherein the data indicates an alert state.

15. A safety vest assembly comprising:
a vest comprising:
a back panel and a front panel, wherein the front panel is joined to the back panel along opposite back panel sides and along left and right shoulder sections, wherein outward facing surfaces of each of the back panel and the front panel comprise at least one band of reflective material and at least one band of lights, and wherein the front panel comprises two halves releasably attachable to each other at a central point on the vest, wherein the releasable attachment is via first and second mating strips comprising hook and loop fasteners, a zipper, buttons, or any combination thereof;
at least one pocket sized and configured for holding a fluid container;
a power supply configured to provide power to the at least one band of lights, the power supply positioned in a water resistant or waterproof pocket on the vest;
a power port configured to provide power to an electronic device, wherein the power port is in electrical communication with the power supply, and provides power to the electronic device via a wired connection, a wireless connection, or both; and
a control configured to modulate a function of the at least one band of lights and the power supply.

16. A worker safety system comprising:
at least one safety vest assembly including:
a vest comprising a back panel and a front panel, wherein the front panel is joined to the back panel along opposite back panel sides and along left and right shoulder sections, wherein outward facing surfaces of each of the back panel and the front panel comprise at least one band of reflective material and at least one band of lights,
a power supply,
at least one pocket sized and configured for holding a fluid container;
a control configured to modulate a function of the at least one band of lights and the power supply, and
a wireless data communications system; and
a control system including computer-executable instructions configured to send data to and receive data from the at least one safety vest assembly, the control system comprising:
at least one processor configured to execute the computer-executable instructions, and
a memory storing the computer-executable instructions.

17. The system of claim 16, wherein the at least one safety vest assembly further comprises a vest location device configured to provides a geo-location of the safety vest assembly, and the control system is configured to receive the geo-location of the at least one safety vest assembly and position the geo-location on a map, wherein the map is a worksite map, a street map, a topographical map, or any combination thereof.

18. The system of claim 17, wherein the vest location device of the safety vest assembly comprises a global positioning system or a cellular positioning system in electrical communication with the power supply via the circuitry.

19. The system of claim 16, wherein the at least one safety vest assembly further comprises an alert system adapted to provide a visual, audible, or tactile alert to a wearer of the vest based on data received via the wireless communications system, wherein the data indicates an alert state.

20. The system of claim 16, wherein the at least one safety vest assembly comprises a power port configured to provide power to an electronic device, wherein the power port is in electrical communication with the power supply; and wherein the wireless data communications system comprises the electronic device.
